(19) United States
(12) Patent Application Publication
(10) Pub. No.: US 2021/0227967 A1
(43) Pub. Date: Jul. 29, 2021

(54) Devices, Systems, and Methods for Creating Healthy Habits in Pediatrics

(71) Applicant: Yonder, LLC, Champlin, MN (US)

(72) Inventors: Courtney A. Hill, Arden Hills, MN (US); Adam Choe, Champlin, MN (US)

(73) Assignee: Yonder, LLC, Champlin, MN (US)

(21) Appl. No.: 17/160,546

(22) Filed: Jan. 28, 2021

Related U.S. Application Data
(60) Provisional application No. 62/967,088, filed on Jan. 29, 2020.

(51) Int. Cl. A46B 15/00

(52) U.S. Cl. CPC A46B 15/0042; A46B 2200/1066; A46B 15/0044

(57) ABSTRACT

Toothbrush training systems and methods are disclosed. A toothbrush training system can include a toothbrush, a reward generator, and means to communicate a musical reward to a user of the toothbrush. The toothbrush can be in communication with a sensor in varying ways. The reward generator can be configured to generate the musical reward based on a signal from the sensor. A method can include providing a user with a cue to clean his/her teeth using a toothbrush; sensing movement, orientation or acceleration of the toothbrush; generating a musical reward for the user based on sensed movement, orientation or acceleration of the toothbrush; and communicating the musical reward to the user.

### CLAIM OF PRIORITY

This application claims the benefit of priority under 35 U.S.C. § 119(e) to U.S. Provisional Patent Application Ser. No. 62/967,088, entitled “DEVICES, SYSTEMS, AND METHODS FOR CREATING HEALTHY HABITS IN PEDIATRICS” and filed on Jan. 29, 2020, the entire content of which is incorporated herein by reference.

### TECHNICAL FIELD

This disclosure is related to habit formation and, in particular, to guiding children on proper tooth brushing techniques.

### BACKGROUND

A toothbrush is an oral hygiene instrument that is critical for cleaning teeth and gums. However, many children do not employ proper tooth brushing habits as recommended by dental associations, such as the American Dental Association (ADA). For example, many children not only fail to brush their teeth for the recommended time period of two minutes, but also fail to brush all of their teeth—some children may only brush their back teeth, while other children may only brush their front teeth. Also, while some children presume they are brushing their teeth for the proper amount of time, they are mostly standing around with the toothbrush in their mouths but not moving. For example, some children use a timer when brushing their teeth. However, while the child brushes his or her teeth, the child on occasion walks around or stands in front of the mirror with the toothbrush statically positioned in his or her mouth. When the timer expires, the child then proceeds to rinse out his or her mouth and wash the toothbrush. In this instance, the child has not brushed his or her teeth for the time period recommended.

### OVERVIEW

In some aspects, this disclosure describes example toothbrush training systems and methods for using the same.

Clause 1: In some examples, a toothbrush training system comprises a toothbrush in communication with a sensor, a reward generator configured to generate a musical reward based on a signal from the sensor, and means to communicate the musical reward to a user of the toothbrush.

Clause 2: In some examples of the toothbrush training system of clause 1, the sensor is incorporated within the toothbrush.

Clause 3: In some examples of the toothbrush training system of clause 1, the sensor is configured to attach to the toothbrush.

Clause 4: In some examples of the toothbrush training system of clause 1, the sensor is separate and spaced form the toothbrush.

Clause 5: In some examples of the toothbrush training system of any one of clauses 1-4, the musical reward includes an audio component and a visual component, wherein the visual component incorporates an animated character.

Clause 6: In some examples of the toothbrush training system of any one of clauses 1-5, the content of the musical reward is dynamically altered based on one or more signals from the sensor.

Clause 7: In some examples of the toothbrush training system of any one of clauses 1-6, the sensor includes an accelerometer or a gyroscope configured to monitor movement, orientation or acceleration of the toothbrush.

Clause 8: In some examples of the toothbrush training system of any one of clauses 1-7, the sensor includes a pressure sensor.

Clause 9: In some examples of the toothbrush training system of any one of clauses 1-8, the sensor includes a pulse oximeter sensor.

Clause 10: In some examples of the toothbrush training system of any one of clauses 1-9, the system further comprises one or more transmitters configured to communicate the signal between the toothbrush and the sensor or between the sensor and the reward generator.

Clause 11: In some examples of the toothbrush training system of any one of clauses 1-10, the means to communicate the musical reward is incorporated into the toothbrush.

Clause 12: In some examples of the toothbrush training system of any one of clauses 1-10, the means to communicate the musical reward is a computer, an electronic tablet, a smart phone, a smart watch, a smart hub, a smart mirror, a smart speaker, a smart wearable, or a home audio system.

Clause 13: In some examples of the toothbrush training system of any one of clauses 1-12, the system further comprises a feedback controller configured to recognize musical rewards resulting in the user performing a desired action.

Clause 14: In some examples of the toothbrush training system of clause 13, the reward generator is configured to generate the musical reward based on one or more signals from the sensor and input from the feedback controller.

Clause 15: In some examples, a method comprises providing a user with a cue to clean his/her teeth using a toothbrush; sensing movement, orientation or acceleration of the toothbrush;

generating a musical reward for the user based on sensed movement, orientation or acceleration of the toothbrush; and communicating the musical reward to the user.

Clause 16: In some examples of the method of clause 15, the musical reward is communicated to the user over a variable time interval schedule while movement, orientation or acceleration of the toothbrush is sensed.

Clause 17: In some examples of the method of clause 15, the musical reward is communicated to the user over a predetermined time interval schedule while movement, orientation or acceleration of the toothbrush is sensed.

Clause 18: In some examples of the method of any one of clauses 15-17, the musical reward is generated after a variable amount of movements, orientation changes or accelerations of the toothbrush are sensed.

Clause 19: In some examples of the method of any one of clauses 15-17, the musical reward is generated after a predetermined amount of movements, orientation changes or accelerations of the toothbrush are sensed.

Clause 20: In some examples of the method of any one of clauses 15-19, the musical reward includes one or more vocal sounds.

Clause 21: In some examples of the method of any one of clauses 15-20, the musical reward includes one or more instrumental sounds.

Clause 22: In some examples of the method of any one of clauses 15-21, the musical reward includes a plurality of chords.

Clause 23: In some examples of the method of clause 22, the plurality of chords is comprised of chords that move away from tonic chords to create dissonance and tension.

Clause 24: In some examples of the method of clause 22, the plurality of chords is comprised of chords creating consonance or resolution.

Clause 25: In some examples of the method of any one of clauses 15-23, the musical reward is comprised of tones that move away from a mean pitch.

Clause 26: In some examples of the method of any one of clauses 15-23, the musical reward is comprised of tones that move toward a mean tone.

Clause 27: In some examples of the method of any one of clauses 15-26, the musical reward includes a tempo that correlates to a tempo of the sensed movement, changes in orientation or acceleration of the toothbrush.

Clause 28: In some examples of the method of any one of clauses 15-27, the musical reward includes a musical segment that randomly repeats itself during the communication of the musical reward to the user.

Clause 29: In some examples of the method of any one of clauses 15-27, the musical reward includes a musical segment that predictably repeats itself during the communication of the musical reward to the user.

Clause 30: In some examples of the method of any one of clauses 15-29, communicating the musical reward to the user includes inducing pleasure of the user through activation of the brain's reward pathways.

These and other examples and features of the present devices, systems, and methods will be set forth, at least in part, in the following Detailed Description. This Overview is intended to provide non-limiting examples of the present subject matter—it is not intended to provide an exclusive or exhaustive explanation. The Detailed Description below is included to provide further information about the present devices, systems, and methods.

### BRIEF DESCRIPTION OF THE DRAWINGS

The drawings illustrate generally, by way of example, but not by way of limitation, various device, system, and method embodiments discussed in this patent document.

FIG. 1 illustrates an example workflow to teach and train a user (child) to be motivated to take an action, as constructed in accordance with at least one embodiment.

FIG. 2 illustrates an example workflow to teach and train a user (child) to be motivated to brush his/her teeth, as constructed in accordance with at least one embodiment.

FIG. 3 illustrates another example workflow to teach and train a user (child) to be motivated to brush his/her teeth, as constructed in accordance with at least one embodiment.

### DETAILED DESCRIPTION

The present inventors recognize that with proper incentivization, one can teach and train a child to be motivated to an action, such as brushing twice a day using proper techniques. Good habit formation takes consistency and practice. To increase the odds of success it is important to provide proper motivation and incentivization.

One example of a healthy habit developed at an early age is toothbrushing. Children should begin to practice healthy oral habits by the first tooth or the age of 1. Poor oral health is linked to many long term chronic health conditions such as heart disease, diabetes, stroke, and adverse pregnancy outcomes. Up to 40% of surveyed adults visit the dentist less than once a year. The brushing habits formed in the formative years have a lasting impact. One in every five children has dental cavities in the United States and there are 51 million hours of school missed due to dental pain each year. Preventing dental disease is a daily endeavor. Many parents can speak to the difficulty of getting their young child's teeth brushed for the two minutes twice each day regimen recommended by the ADA. There is a paucity of tools to help parents achieve this and distraction techniques are commonly taught. These techniques do not form habits. A habit for young children of twice daily brushing for two minutes can only maintain or improve oral health.

Another example of a healthy habit developed in the same age range would be getting children to wean completely off of pacifier use and thumbsucking. It is estimated that of the 90% of children who thumbsuck, one in ten will continue to suck on their thumb past the age of four. It is recommended that children stop using a pacifier by the age of 1 when possible and thumbsucking by the age of four. Pacifier use can increase the potential of an ear infection by up to 29%, and thumbsucking (and pacifier use) can increase the likelihood of the need of dental work if the habit is maintained for a prolonged period of time after the age of two in the form of protruding front teeth or a crossbite. These dental changes will persist to adult teeth.

Another example of a health habit developed in the same age range is potty training. The expected age of potty training is 18-30 months with most children being successfully potty trained by 24 months. The impact of delayed potty training has both physical and mental impact potential. Some potential impacts of delayed potty training include increased likelihood of urinary tract infections, higher incidence rates of incontinence, and higher increase of daytime wetting.

Yet another example of a good habit developed at this age range is healthy eating. Dietary habits formed by the age of seven tend to persist into adolescence. Children who consume low fiber, high fat, high calorie foods at age 7 have a higher risk of increased adiposity in early adolescence compared to those who do not have the same food patterns.

Other examples of habits developed at this age range are exercise, sharing, kindness, and other social or physical skills or habits for healthy pediatric development.

Devices, systems, and methods described herein can form habit by way of the brain's innate reward pathway. One method of motivation that is not currently utilized to drive habit formations is the use of music or audio rewards to incentivize a desired habit. The habit formation can be formed by utilizing hardware that attaches to a toothbrush (or is integrated in a smart toothbrush), for example, and contains a sensor (gyroscope, temperature, moisture, accelerometer, pressure, proximity, IR sensor, light sensor, motion sensor), to detect the brushing motion (activity). The sensor can be separate component from the toothbrush and can attach to any manual or electric toothbrush. The sensors can be of various sizes to accommodate the circumference or diameter of the toothbrush they attach to. The sensor can be a permanent addition to the toothbrush once in place or can be removeable. The sensor can also be separate from the toothbrush and not require direct contact with the toothbrush in order to detect the brushing activity. This can be within the same room as the user. One example could be that the sensor is integrated into the mirror of the bathroom or another example is a standalone sensor on the counter. Another example could be that the sensor is integrated with a smart device that can be located in the bathroom. This sensor hardware can communicate (via hardwired, Bluetooth, Wi-Fi, RFID, Radio Frequency, Infrared) with a smart device (mobile phone, tablet, smart speaker, or any other smart device such as a Amazon Echo, Google Nest, or the toothbrush itself etc.) to recognize that the brushing motion (activity) is taking place. The smart device can then output an audio reward (rewards can be but not limited to: music, song, or words of encouragement) after a variable amount of time is spent brushing such that it is unpredictable (random intervals between reward and random length of reward) for the child and works to encourage them to keep brushing. As another example, the toothbrush itself could be the source of the audio output by way of sound waves in the air or vibration to the teeth that create audible rewards through bone conduction. The resolution of the cycle can be when the audio reward concludes and there is no further reward. This could coincide with 2 full minutes of brushing, for example. The audio reward could also be used in combination with a visual reward. One example would be a character that sings, dances to music, or offers words of encouragement. In this example, the audio and visual reward could be displayed on a smartphone, tablet, or smart mirror.

The reward pathway is comprised of the ventral tegmental area, nucleus accumbens, hypothalamus, and ventral striatum, among others. This pathway is mediated by dopamine, which is thought to be involved in reward-related incentive learning and is felt to be the brain's way of reinforcing behavior. It is believed that unexpected rewards can result in particularly high amounts of DA release and greater learning. The strongest response of dopamine occurs when outcomes are better than what is expected. The nucleus accumbens has outputs that can modulate motor behaviors and dopamine release. The connection between nucleus accumbens and the amygdala plays a role in creating the behavior that is a response to reward cues. The reward pathway is powerful and is the same pathway that unnatural rewards such as illicit drugs and gambling act upon. Instead of using an undesirable reward, the present inventors recognize the potential benefit of utilizing pleasing music that is a natural reward in and of itself.

Music can be utilized to activate the reward pathway in response to tooth brushing. Music is a universally important aspect of life and even infants respond to music. Pleasurable music can activate the nucleus accumbens even if it is unfamiliar. Familiar, pleasurable music can activate the ventral striatum. Humans can learn to expect a certain progression of tones in childhood, with evidence for this as young as 30 months. Two year old children have been shown to have the same neurophysiological changes that older children and adults do with displeasing chord progressions; they have already learned the musical semantics in what is expected to be the next chord in a series and neurologically display discontent when the chords do not progress as they should. Expectations can be created from note to note or phrase to phrase. Dopamine is released in two different musical situations. The first is during desire and anticipation of hearing expected sounds in familiar music and the second is during a positive prediction error with less familiar music, or when what you hear next is more pleasing than what you expected to hear next. This creation of expectations within music and providing a more pleasing than expected audio reward can be used, for example, to create a reward that increases dopamine release after a desired action such as tooth brushing movement.

Expectations in western music have to do both with chords (set of pitches heard simultaneously) and with notes (singular pitches). A tonic chord represents resolution in a piece of music and movement away from it creates dissonance, while moving back to it instills consonance. The individual notes in a melody tend to revolve around the mean pitch such that when the phrase is comprised of notes that move away from the mean pitch, the expectation is that the next phrase will regress back toward the mean pitch. There is also an expectation that notes continue in an ascending or descending pattern in a given phrase. Artists, musicians, producers, composers, and creatives use this knowledge to create music that is pleasing. In one example, dissonance can be created with the chords of the audio reward in order to encourage the user to continue brushing movements in order to achieve the next portion of the audio reward or a separate subsequent audio reward which contains chords that produce consonance. Another example could be the use of the audio reward that includes pitches that move away from the mean pitch and encourage continued motion in order to achieve the expected movement back toward the mean pitch in subsequent pitches of the same audio reward or in subsequent separate audio rewards.

One aspect of music that can be particularly important is the tempo. When experiencing music, the listener is likely to feel compelled to move to the beat. However, the tempo plays a significant role in mediating cardiovascular changes such as heart rate. It is important to choose a tempo that is neutral for cardiovascular effects but provides a good rhythm for the desired movement of brushing the teeth. Young children in our target age range have an awake heart rate in the range of 70 to 110. A cadence of 80 to 100 beats per minute falls nicely within this range and also provides a reasonable cadence for the movement of the toothbrush back and forth in the mouth. It is believed that the use of a cadence of 100-140 beats per minute can provide a cadence to promote an excited emotional state to continue brushing. One example of the use of cadence in the audio reward can be to encourage a user who is brushing too slowly or inconsistently. The tempo or cadence of the audio reward can be increased to encourage more movement. In another example, the opposite is true. If tooth brushing movements are sensed to be too fast for adequate brushing, then the cadence or tempo of the audio reward can be altered to encourage slowing of the brushing movements. An additional example could be where the tempo in the audio reward is in a closed loop system with the sensor such that machine learning or artificial intelligence can learn the user's typical brushing tempo or a desired brushing tempo and produce audio reward output that encourages the movement tempo.

The musical reward can be given in phrases and on a variable interval schedule. Humans have the ability to relate sounds together that are separated by seconds and minutes. There can be a distinct preference for a variable interval (time required between rewards) reward schedule rather than a variable ratio (actions required between rewards). In this system, that translates to a preference for rewards that occur after a variable length of time has passed rather than a variable number of brushes or movements. As an example, a variable interval reward schedule could be that the audio reward is given after a discrete amount of time has passed that the user is performing the brushing activity; the reward output would occur after random or non-random lengths of time have passed performing the activity. Alternatively, an example of the variable ratio reward schedule would be for the audio rewards to occur after a number of brushes or movements have occurred; the reward output would occur after random or non-random numbers of movements have occurred.

There are other combinations of technologies that can be combined to accomplish the same looping feedback system that are both open and closed loop. Some other examples of these systems are described below.

Example one: is with the use of affective computing to analyze visual feedback of an individual's emotional state. This can be utilized to track habit formation and emotional response to inputs. A smart mirror, camera, or another recording device such as a smart phone that is continuously recording, sensing, and analyzing body language or facial expressions, such as the eyes and brow (or any facial or body language) region of an individual, to determine the emotional state to deliver an audio reward based on machine learning (ML) and artificial intelligence (AI) of different emotional responses and their characteristics such as smiles, wrinkles near the eyes. An example of the full feedback loop can be as follows: the human shows the signs of happiness on their face (smile, wrinkles near their eyes, etc.), the sensor (in this case, a smart mirror that can record video), records and analyzes the data (the emotion happiness), the data of the expected behavior is analyzed by the reward generator computer via AI/ML to determine if the expected behavior is achieved. If yes, the system plays a variable audio reward for the individual to hear which positively reinforces happiness.

Example two: is with the use of speech analysis, machine learning, and artificial intelligence. A smart device or speaker with a microphone that is continuously recording the conversations it hears from individuals to determine if an expected behavior is being achieved. An example of the full feedback loop can be as follows: A parent is speaking to their child, the sensor (smart speaker) is listening for specific keywords, such as “good job” “way to go”, or other combinations of words associated with positive outcomes or behaviors. The sensor sends that data to the reward generator (in this example, a smart speaker or smartphone) and a variable audio reward is sent to the child to positively reinforce the action. The verbal cue could also be paired with a pressure sensor in the potty training toilet that senses the use of the toilet. This feedback loop can be to positively reinforce potty training. In this example, the sensor in the potty training toilet seat would activate the audio sensor to listen for keywords from both the parents and children. The system would learn via AI/ML (and pre-programmed keywords) to provide the audio rewards for proper potty training events.

Example three: is with the use of a pressure sensor in the tip of a pacifier to sense for pressure changes signaling the use of the pacifier and in this case the variable musical reward might only be delivered when there was a lack of signal from the sensor, which can indicate the unused state of the pacifier. The variable audio reward could also be delivered every time the pacifier is removed from the mouth of the child. The sensor data (pressure or moisture) can be sent via Bluetooth to a reward generator (smartphone or smart speaker) that plays the variable audio reward when it recognizes the removal of the pacifier signified by lack of pressure, or some other indicator like lack of moisture or saliva, or lack of sound of suction.

Example four: is with the use of emotional prosody in a system to sense, record and analyze an individual's tone, timbre, pitch, speech rate, and loudness to determine the emotional state of an individual. By utilizing machine learning and artificial intelligence, the sensor can record the individual, the individual can be rewarded for specific emotional responses that are determined through emotional prosody. An example of the full feedback loop can be as follows: A parent is speaking with their child and the system is sensing and recording the conversation. The sensor sends the conversation data (tone, timbre, pitch, speech rate, and loudness) to the reward generator (in this case a smart speaker) to analyze the data for the expected behavior (in this case happiness), the reward generator analyzes and determines happiness from both individuals and a variable audio reward is sent.

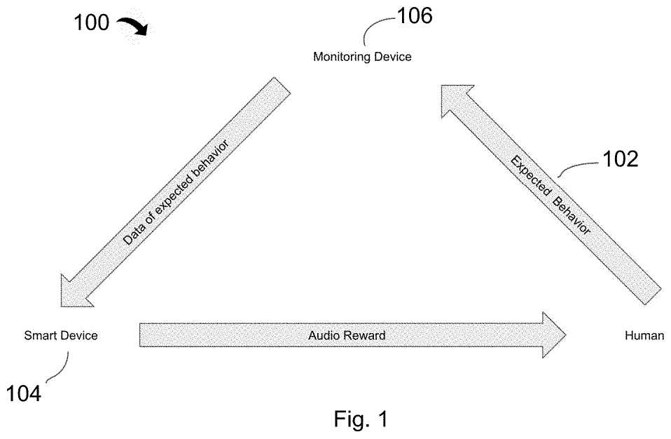

FIGS. 1, 2, and 3 illustrate example workflows 100, 200, 300 including combinations of smart devices, sensors, and inputs to create a feedback cycle to deliver a variable music or audio reward to a user to incentivize and create habit formation. The present workflows are not limited to these specific combinations.

Referring specifically to FIG. 1, the expected behavior 102 can be a physical behavior, physiological behavior, emotional behavior, social behavior, or any combination of the previously listed behaviors. The previously listed behaviors are not limited to one user and can be a shared response by multiple user at the same time. The smart device 104 can be a computer, an electronic tablet, a smart phone, a smart watch, a smart hub, a smart mirror, a smart wearable, a home audio system, or similar smart device. The monitoring device 106 can be a sensor in the form of a pressure sensor, accelerometer, gyroscope, pulse oximeter, image recognition, motion sensor, or audio sensor and can be used alone or in various combinations to sense, monitor, or record the expected behavior.

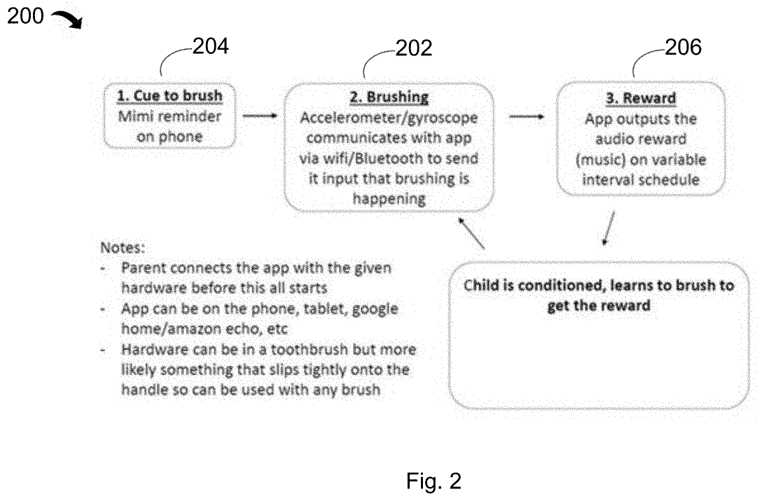

Referring specifically to FIG. 2, the example workflow 200 includes use a toothbrush (sensor), movement of which (brushing 202) is cued at 204 through use of smartphone app (smart device), and rewarded at 206 also via the smartphone.

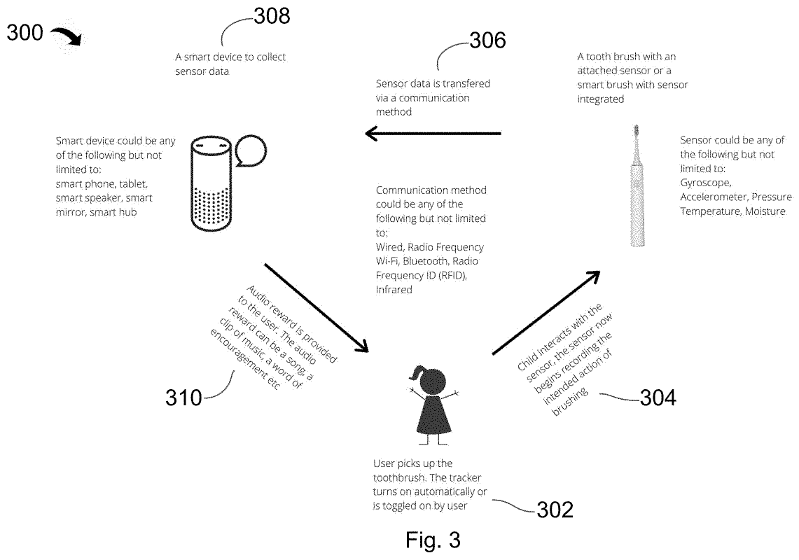

Referring specifically to FIG. 3, the example workflow 300 includes a user picking up a toothbrush at 302. The user interacts with a sensor in communication with the toothbrush at 304. The sensor records the action of the toothbrush. Sensor data is transferred via a communication method at 306 and is collected by a smart device at 308. An audio reward is provided to the user at 310.

The above Detailed Description includes references to the accompanying drawings, which form a part of the Detailed Description. The Detailed Description should be read with reference to the drawings. The drawings show, by way of illustration, specific embodiments in which the present devices, systems, and methods can be practiced. These embodiments are also referred to herein as “examples.” The above Detailed Description is intended to be illustrative and not restrictive. For example, the above-described examples (or one or more features or components thereof) can be used in combination with each other. Other embodiments can be used, such as by one of ordinary skill in the art upon reviewing the above Detailed Description. Also, various features or components have been or can be grouped together to streamline the disclosure. This should not be interpreted as intending that an unclaimed disclosed feature is essential to any claim. Rather, inventive subject matter can lie in less than all features of a particular disclosed embodiment.

The scope of the present devices, systems, and methods should be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended; that is, a device, system, or method that includes features or components in addition to those listed after such a term in a claim are still deemed to fall within the scope of that claim. Moreover, in the following claims, the terms “first,” “second” and “third,” etc. are used merely as labels, and are not intended to impose numerical requirements on their objects.

The Abstract is provided to allow the reader to quickly ascertain the nature of the technical disclosure. It is submitted with the understanding that it will not be used to interpret or limit the scope or meaning of the claims.

What is claimed is:

1. A method, comprising:
providing a user with a cue to clean his/her teeth using a toothbrush;
sensing movement, orientation or acceleration of the toothbrush;
generating a musical reward for the user based on sensed movement, orientation or acceleration of the toothbrush; and
communicating the musical reward to the user.

2. The method of claim 1, wherein the musical reward is communicated to the user over a variable time interval schedule while movement, orientation or acceleration of the toothbrush is sensed.

3. The method of claim 1, wherein the musical reward is communicated to the user over a predetermined time interval schedule while movement, orientation or acceleration of the toothbrush is sensed.

4. The method of claim 1, wherein the musical reward is generated after a variable amount of movements, orientation changes or accelerations of the toothbrush are sensed.

5. The method of claim 1, wherein the musical reward is generated after a predetermined amount of movements, orientation changes or accelerations of the toothbrush are sensed.

6. The method of claim 1, wherein the musical reward includes one or more vocal sounds.

7. The method of claim 1, wherein the musical reward includes one or more instrumental sounds.

8. The method of claim 1, wherein the musical reward includes a plurality of chords.

9. The method of claim 8, wherein the plurality of chords is comprised of chords that move away from tonic chords to create dissonance and tension.

10. The method of claim 1, wherein the musical reward is comprised of tones that move away from a mean pitch.

11. The method of claim 1, wherein the musical reward is comprised of tones that move toward a mean tone.

12. The method of claim 1, wherein the musical reward includes a tempo that correlates to a tempo of the sensed movement, changes in orientation or acceleration of the toothbrush.

13. The method of claim 1, wherein the musical reward includes a musical segment that randomly repeats itself during the communication of the musical reward to the user.

14. The method of claim 1, wherein the musical reward includes a musical segment that predictably repeats itself during the communication of the musical reward to the user.

15. The method of claim 1, wherein communicating the musical reward to the user includes inducing pleasure of the user through activation of the brain's reward pathways.

16. A toothbrush training system, comprising:
a toothbrush in communication with a sensor;
a reward generator configured to generate a musical reward based on a signal from the sensor; and
means to communicate the musical reward to a user of the toothbrush.

17. The toothbrush training system of claim 16, wherein the musical reward includes an audio component and a visual component, the visual component incorporating an animated character.

18. The toothbrush training system of claim 16, wherein content of the musical reward is dynamically altered based on one or more signals from the sensor.

19. The toothbrush training system of claim 16, further comprising one or more transmitters configured to communicate the signal between the toothbrush and the sensor or between the sensor and the reward generator.

20. The toothbrush training system of claim 16, further comprising a feedback controller configured to recognize musical rewards resulting in the user performing a desired action.
